(19) United States
(12) Patent Application Publication
(10) Pub. No.: US 2024/0335012 A1
(43) Pub. Date: Oct. 10, 2024

(54) BRAIDED WATCH BAND AND WATCH

(71) Applicant: Huawei Technologies Co., Ltd., Shenzhen (CN)

(72) Inventors: Jiawei Chen, Dongguan (CN); Kang Fu, Dongguan (CN); Junjie Yang, Dongguan (CN); Shenglan Yuan, Dongguan (CN); Tianyu Cheng, Dongguan (CN); Yanjie Chen, Shenzhen (CN)

(21) Appl. No.: 18/292,621

(22) PCT Filed: Jul. 26, 2022
(86) PCT No.: PCT/CN2022/107916

§ 371 Date: Jan. 26, 2024

(30) Foreign Application Priority Data
Jul. 30, 2021 (CN) 202121778118.9

(51) Int. Cl. A44C 5/00; G04B 37/14

(52) U.S. Cl. CPC A44C 5/0053; G04B 37/1493

(57) ABSTRACT

In some embodiments, a braided watch band includes a braided band. The braided band includes a first braided band branch and a second braided band branch arranged in a thickness direction. The braided band further includes a first binding yarn and a second binding yarn. The first braided band branch and the second braided band branch to form a separate section and joint sections. In the joint sections, the first binding yarn and the second binding yarn form an orthogonally locking structure. In the separate section, the first binding yarn passes through one of the first braided band branch or the second braided band branch, and the second binding yarn passes through the other of the first braided band branch or the second braided band branch. Portions of the first braided band branch and the second braided band branch at the separate section form a loop.

### CROSS-REFERENCE TO RELATED APPLICATIONS

This application is a national stage of International Application No. PCT/CN2022/107916, filed on Jul. 26, 2022, which claims priority to Chinese Patent Application No. 202121778118.9, filed on Jul. 30, 2021. Both of the aforementioned applications are incorporated herein by reference in their entireties.

### TECHNICAL FIELD

This application relates to the field of braiding technologies, and in particular, to a braided watch band and a watch.

### BACKGROUND

The main part of a braided watch band is a braided band, which can be connected to a watch body mostly in the following two manners after processing. One manner is end link connection. The braided band is combined with end links through a specific process and then connected to the watch body. The other manner is non-end link connection. The braided band is folded in half and bonded by using an adhesive film to form a loop, and then inserted by spring bars and connected to the watch body.

However, in the manner of connecting the braided band and the watch body with the end links, the end links need to be purchased separately. Consequently, accessories and costs of the watch band increase, and existence of the end links may also affect overall aesthetic of the watch. In the manner of bonding the braided band to form the loop by using the adhesive film, introduction of the adhesive film makes the watch band hard and air permeability poor, and an adhesive part is at risk of cracking.

Therefore, how to provide a braided watch band in which a loop and a braided band are integrally formed without end links is an urgent problem to be resolved.

### SUMMARY

This application provides a braided watch band and a watch, to provide a braided watch band in which a loop and a braided band are integrally formed without end links.

According to a first aspect, this application provides a braided watch band. The braided watch band includes an integrally braided band. Specifically, the braided band includes a first braided band branch and a second braided band branch arranged in a thickness direction. The first braided band branch may include one or more first webbing layers, and the second braided band branch may include one or more second webbing layers. It should be understood that a thickness of the braided band may be achieved by adjusting a quantity of the first webbing layer or the second webbing layer. Specifically, the quantity of the first webbing layer in the first braided band branch may be configured based on a requirement, and the quantity of the second webbing layer in the second braided band branch may be configured based on a requirement. Details are not described herein. Based on use characteristics of the watch band, the first webbing layer is arranged in a band shape in a length direction, and the second webbing layer is arranged in a band shape in the length direction.

It is worth noting that the braided band further includes a first binding yarn and a second binding yarn. The first binding yarn works in conjunction with the second binding yarn in the length direction to braid the first braided band branch and the second braided band branch to form a separate section and joint sections. In the joint sections, the first binding yarn and the second binding yarn respectively pass through the first braided band branch and the second braided band branch to form an orthogonally locking structure. In the separate section, the first binding yarn passes through the first braided band branch, and the second binding yarn passes through the second braided band branch, or the first binding yarn passes through the second braided band branch, and the second binding yarn passes through the first braided band branch. It should be understood that because of a structural configuration of the first binding yarn and the second binding yarn in the separate section and the joint sections, the first braided band branch and the second braided band branch form a loop at the separate section.

The braided band of the braided watch band provided in this application is integrally formed by braiding the first braided band branch, the second braided band branch, the first binding yarn, and the second binding yarn. The structural configuration of the first binding yarn and the second binding yarn in the separate section and the joint sections enables the first braided band branch and the second braided band branch to form the loop at the separate section. In the braided watch band provided in this application, the braided band and the loop are integrally braided and formed without using an end link structure, and there is no adhesive film for bonding. The loop can work in conjunction with a corresponding structural component to achieve fixing and connection of the braided watch band relative to the watch body when worn, so that stability of the connection between the braided watch band and the watch body can be enhanced. In addition, in this application, a braiding process routine of the braided watch band is short, the braided band has a simple structure without any accessory, and has high integrity in appearance, which can satisfy a requirement of a user for quick mounting and removal.

When the structure of the braided band is specifically configured, the braided band may be configured to have at least one loop. Specifically, the structure of the braided band has at least one of the following specific implementations.

In a specific implementation, each end of the braided band is provided with the loop. In other words, each end of the braided band is connected to the watch body through the loop. It is worth noting that a width of the braided band may be adjusted arbitrarily based on a need to adapt to the watch body. A length of the braided band may be changed arbitrarily based on an actual need. In addition to being achieved by adjusting the quantity of the first webbing layer or the second webbing layer, a thickness of the braided band may further be achieved by replacing yarns of different thicknesses. Certainly, to ensure elasticity while facilitating a user to wear, ensuring hand feeling and surface appearance diversity, for example, high-elastic spandex covered yarn may be selected for warp yarns of the webbing layer close to the user in the braided band between the two loops when braiding, and draw texturing yarn (draw texturing yarn, DTY) nylon may be selected for the webbing layer distant from the user. It should be understood that the foregoing structural configuration may alternatively be used in the entire braided band. Details are not described herein again.

In another specific implementation, one end of the braided band is provided with a loop. The braided band is connected to the watch body through the loop. As for a fixing manner of the other end of the braided band, a tail fixing structure may be provided on the braided band. The tail fixing structure may be configured to form an interlinked ring structure relative to the watch body to fix the other end of the braided band. Specifically, a detachable mechanism is mounted on the watch body. The detachable mechanism and lugs of the watch body form a closed ring structure. The other end of the braided band may be inserted into the closed ring structure, and form the interlinked ring structure through the tail fixing structure. For example, the tail fixing structure includes a loop and a hook provided on an outer surface of the braided band. In this implementation, the user may freely adjust a length of an actual use part of the braided band based on a requirement to match a wrist, thereby achieving stepless adjustment.

Certainly, the tail fixing structure may alternatively be a snap provided at a tail of the braided band. When the braided band passes around the closed ring structure of the watch body, the snap located at the tail of the braided band is optionally inserted into the braided band to form the interlinked ring structure to fix the other end of the braided band relative to the watch body. It is worth noting that the tail fixing structure may alternatively be implemented by a plurality of other mechanisms. For example, the tail fixing structure may alternatively be a magnetic suction structure provided at the tail of the braided band.

When the loop is specifically configured, an avoiding hole is provided on an inner surface of the loop. The avoiding hole is used to avoid a release bar on a spring bar, to facilitate the user to remove the braided band from the watch body.

When structures of the first webbing layer and the second webbing layer are selected, the first webbing layer and the second webbing layer may be configured to be in one of a plain pattern, a twill pattern, or a satin pattern. Certainly, the first webbing layer and the second webbing layer may alternatively be configured to be in another fabric pattern. Details are not described herein again.

According to a second aspect, this application further provides a watch. The watch includes the braided watch band, the watch body, and the spring bar in any technical solution provided in the first aspect. At least one end of the braided band in the braided watch band is provided with a loop. The loop is connected to the watch body through the spring bar.

In the braided watch band of the watch provided in this application, the braided band and the loop are integrally braided and formed without using an end link structure, and there is no adhesive film for bonding. The loop can work in conjunction with the spring bar to achieve fixing and connection of the braided watch band relative to the watch body when worn, so that stability of the connection between the braided watch band and the watch body can be enhanced. In addition, in the watch provided in this application, a braiding process routine of the braided watch band is short, the braided band has a simple structure without any accessory, and has high integrity in appearance, which can satisfy a requirement of a user for quick mounting and removal.

Because the braided band may be provided with one loop, or may be provided with two loops, there are at least the following several implementations for connection between the braided watch band and the watch body in the watch provided in this application.

In a possible implementation, when each end of the braided band is provided with the loop, one spring bar is fitted in the loop, and two ends of the spring bar protrude out of the loop to connect to the watch body.

In another possible implementation, one end of the braided band is provided with the loop, one spring bar is fitted in the loop, and two ends of the spring bar are pivotally connected to the watch body. The other end of the braided band is provided with a tail fixing structure, and the tail fixing structure forms an interlinked ring structure relative to the watch body.

When the structure of the spring bar is configured, a peripheral side of the spring bar may be provided with a release bar. The release bar may be embedded in an avoiding hole at the loop in the braided band, to facilitate the user to remove the spring bar from the watch body, thereby achieving a purpose of quickly replacing the braided watch band.

### BRIEF DESCRIPTION OF THE DRAWINGS

FIG. 1 is a diagram of a structure of a watch using end links in conventional technologies;

FIG. 2 is a diagram of a specific structure of a braided watch band in FIG. 1;

FIG. 3 is a diagram of another structure of a watch using end links in conventional technologies;

FIG. 4 is a diagram of a specific structure of a braided watch band in FIG. 3;

FIG. 5 is a diagram of a structure of a watch without using end links in conventional technologies;

FIG. 6 is a diagram of a specific structure of a braided watch band in FIG. 5;

FIG. 7 is a schematic diagram of a structure of a watch according to an embodiment of this application;

FIG. 8 is a diagram of a specific structure of a braided watch band shown in FIG. 7;

FIG. 9 is a partial cross-sectional view of the braided watch band of FIG. 8 at a plane B;

FIG. 10 is a schematic diagram of manufacturing the braided watch band shown in FIG. 8;

FIG. 11 is a diagram of another specific structure of the braided watch band shown in FIG. 7;

FIG. 12 is a schematic diagram of a structure of a watch body in a watch according to an embodiment of this application;

FIG. 13 is a schematic diagram of another structure of a watch according to an embodiment of this application;

FIG. 14 is a schematic diagram of another structure of a watch according to an embodiment of this application; and

FIG. 15 is a schematic diagram of a structure of a spring bar in a watch according to an embodiment of this application.

### DETAILED DESCRIPTION OF ILLUSTRATIVE EMBODIMENTS

To facilitate understanding of a braided watch band provided in embodiments of this application, an application scenario of the braided watch band provided in this application is first described. The braided watch band provided in embodiments of this application and a watch body are combined to form a watch for a user to wear. A main part of the braided watch band is a braided band. There are two main connection manners between the braided band and the watch body after processing. Specifically, the two manners are using end links and not using end links.

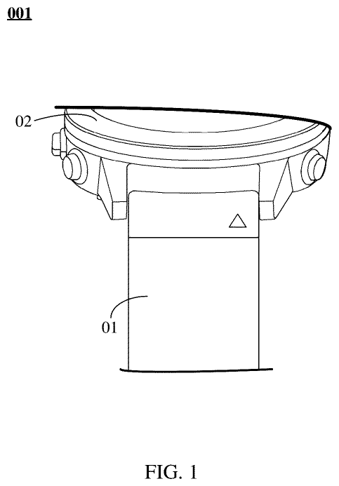

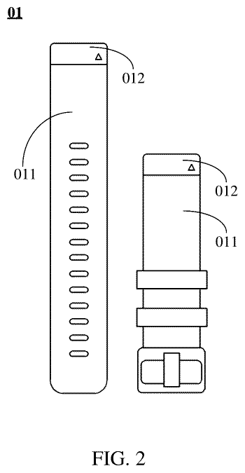

FIG. 1 is a diagram of a structure of a watch 001 using end links in conventional technologies. The watch 001 includes a braided watch band 01 and a watch body 02. FIG. 2 is a diagram of a specific structure of the braided watch band 01 in FIG. 1. Refer to the structure shown in FIG. 2 with reference to FIG. 1. A braided band 011 of the braided watch band 01 is combined with end links 012 through a specific process, then connected to the watch body 02. The end link 012 serves as a loop structure.

However, in the watch body 02 shown in FIG. 1 and FIG. 2, introduction of the end link 012 increases accessories and costs, and existence of the end link 012 also affects overall aesthetic of the watch.

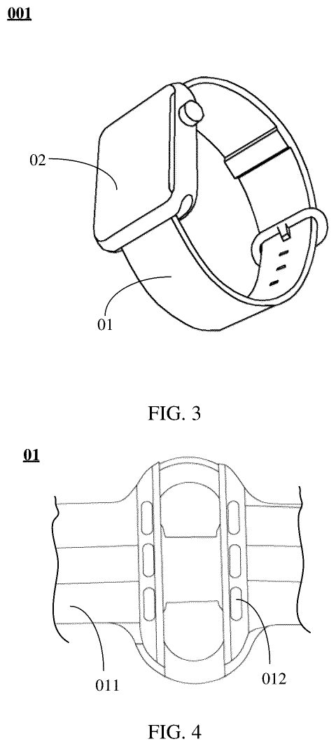

FIG. 3 is a diagram of another structure of a watch 001 using end links in conventional technologies. The watch 001 includes a braided watch band 01 and a watch body 02. FIG. 4 is a diagram of a specific structure of the braided watch band 01 in FIG. 3. Refer to the structure shown in FIG. 4. A head part of a braided band 011 of the braided watch band 01 is provided with end links 012, and the end link 012 wraps the braided band 011 to connect to the watch body 02 by side slipping. For example, refer to the structure shown in FIG. 3.

Although the end link 012 in the watch 001 shown in FIG. 3 and FIG. 4 is hidden in the watch body 02 as a loop, this solution has a great limitation, and the braided watch band 01 can only be combined with the watch body 02 with a fixed style to form the watch 001.

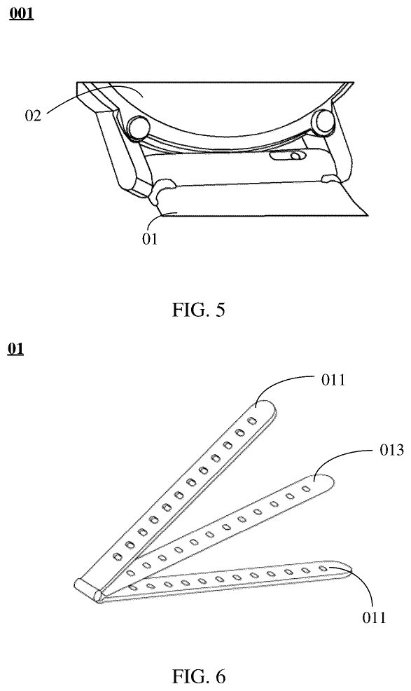

FIG. 5 is a diagram of a structure of a watch 001 without using end links in conventional technologies. The watch 001 includes a braided watch band 01 and a watch body 02. FIG. 6 is a diagram of a specific structure of the braided watch band 01 in FIG. 5. Refer to the structure shown in FIG. 6 with reference to FIG. 5. After being folded in half, a braided band 011 is bonded by using an adhesive film 013 to form a loop.

Although compared with the watch 001 shown in FIG. 3 and FIG. 4, the watch 001 shown in FIG. 5 and FIG. 6 does not use an end link structure, introduction of the adhesive film 013 in the watch body 02 shown in FIG. 5 and FIG. 6 makes the braided watch band 01 hard and air permeability poor, and an adhesive part is also at risk of cracking.

In view of this, embodiments of this application provide a braided watch band and a watch, to provide a braided watch band in which a loop and a braided band are integrally formed without end links.

Terms used in the following embodiments are merely intended to describe specific embodiments, and are not intended to limit this application. As used in the specification and the appended claims of this application, the singular expressions “a/an”, “one”, “said”, “the above”, “the” and “this” are intended to also include such expressions as “one or more”, unless otherwise the context clearly indicates to the contrary.

Reference to “an embodiment”, “some embodiments”, or the like described in the specification means that one or more embodiments of this application include a specific feature, structure, or characteristic described with reference to embodiments. Therefore, statements “in one embodiment”, “in some embodiments”, “in other embodiments”, “in some other embodiments”, and the like that differ in this specification do not necessarily refer to the same embodiment, but rather means “one or more but not all embodiments”, unless otherwise specified. The terms “include”, “comprise”, “have”, and variations thereof all mean “including, but not limited to”, unless otherwise specified.

The following clearly and completely describes the technical solutions in embodiments of this application with reference to the accompanying drawings in embodiments of this application.

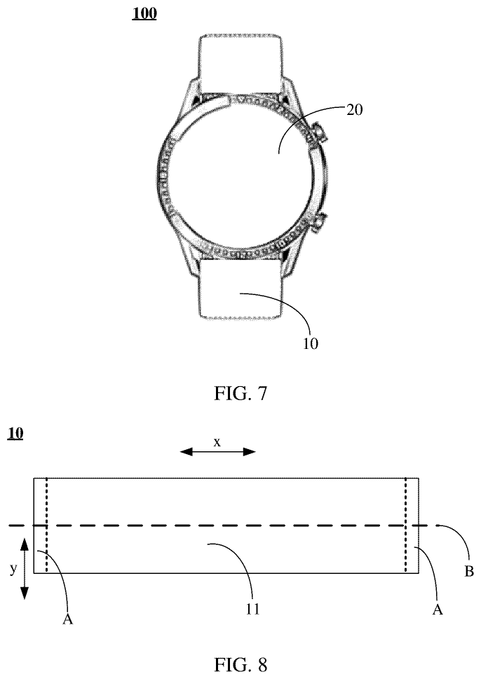

FIG. 7 is a schematic diagram of a structure of a watch 100 according to an embodiment of this application. According to the structure shown in FIG. 7, the watch 100 provided in this embodiment of this application includes a braided watch band 10 and a watch body 20. The braided watch band 10 is integrally formed by braiding. It should be understood that the “watch 100” generally refers to a wrist wearable device, and may also be interpreted as a wristband or the like. FIG. 8 is a diagram of a specific structure of the braided watch band shown in FIG. 7. According to the structure shown in FIG. 8, a loop A is formed at each end of a braided band 11 of the braided watch band 10. Because the loop A is formed at each end of the braided band 11, when wearing the watch 100 provided in an embodiment of this application, a user needs to rely on elasticity of the braided watch band 10.

To facilitate understanding of a structure of the braided band 11, meanings of a “length direction”, a “width direction”, and a “thickness direction” for the braided watch band 10 are first introduced. According to the structure shown in FIG. 8, the “length direction” refers to an extension direction of the braided watch band 10 from one loop A to the other loop A, that is, a direction x marked in FIG. 8. The “wideness direction” refers to a direction y marked in FIG. 8. The direction y is perpendicular to the direction x. The “thickness direction” refers to a direction perpendicular to both the direction x and the direction y and not marked in FIG. 8. The term “inner side” refers to a side of the braided watch band 10 facing a wrist of the user when worn. Correspondingly, the term “outer side” refers to a side of braided watch band 10 facing away from the wrist of the user when worn.

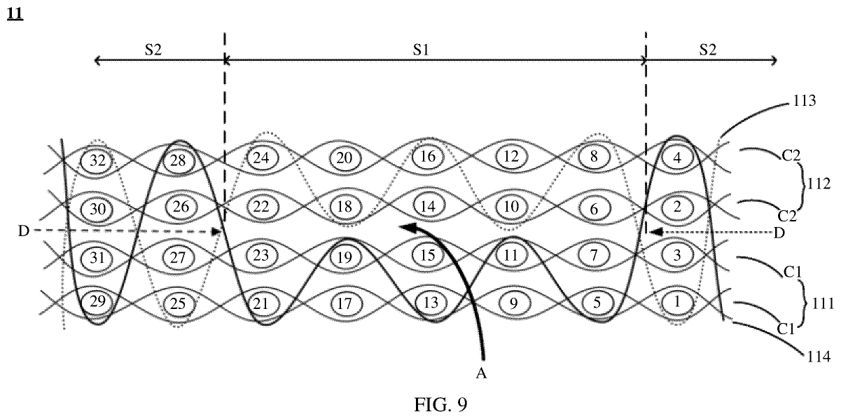

FIG. 9 is a partial cross-sectional view of the braided watch band 10 of FIG. 8 at a plane B. Specifically, FIG. 9 is a cross-sectional view of the loop A at a right section in FIG. 8. Refer to the structure shown in FIG. 9. The braided band 11 includes a first braided band branch 11 and a second braided band branch 112 arranged in the thickness direction. For example, two first webbing layers C1 are provided in the first braided band branch 11. In addition, for example, two second webbing layers C2 are provided in the second braided band branch 112. The first webbing layer C1 is arranged in a band shape in the length direction, and the second webbing layer C2 is arranged in a band shape in the length direction. It should be understood that a thickness of the braided band 11 may be achieved by adjusting a quantity of the first webbing layer C1 or the second webbing layer C2. The quantity of the first webbing layer C1 in the first braided band branch 11 may be configured based on a requirement, and the quantity of the second webbing layer C2 in the second braided band branch 112 may be configured based on a requirement. Details are not described herein.

Still refer to the structure shown in FIG. 9. It is worth noting that the braided band 11 further includes a first binding yarn 113 and a second binding yarn 114. The first binding yarn 113 works in conjunction with the second binding yarn 114 in the length direction to braid the first braided band branch 11 and the second braided band branch 112 to form a separate section S1 and joint sections S2. In the joint sections S2, the first binding yarn 113 and the second binding yarn 114 respectively pass through the first braided band branch 11 and the second braided band branch 112 to form an orthogonally locking structure. According to the structure shown in FIG. 9, the first binding yarn 113 and the second binding yarn 114 transit from the joint sections S2 to the separate section S1 and finally intersect at junction points D. In the separate section S1, the first binding yarn 113 passes through the second braided band branch 112, and the second binding yarn 114 passes through the first braided band branch 11. It should be understood that because of a structural configuration of the first binding yarn 113 and the second binding yarn 114 in the separate section S1 and the joint sections S2, the first braided band branch 11 and the second braided band branch 112 form the loop A at the separate section S1. Because a loop body of the loop A is formed by fabric and is integrally formed with the braided band 11, the loop A has high tensile strength. Certainly, further reinforcement may be performed by stitching threads and tension cloth to satisfy a reliability requirement.

With reference to the structures shown in FIG. 8 and FIG. 9, specifically, the braided band 11 of the braided watch band 10 provided in an embodiment of this application is integrally formed by braiding the first braided band branch 11, the second braided band branch 112, the first binding yarn 113, and the second binding yarn 114. In the braided watch band 10, the braided band 11 and the loop A are integrally braided and formed without using an end link structure, and there is no adhesive film for bonding. The loop A can work in conjunction with a corresponding structural component to achieve fixing and connection of the braided watch band relative to the watch body 20 when worn, so that stability of the connection between the braided watch band 10 and the watch body 20 can be enhanced. In addition, in embodiments of this application, a braiding process routine of the braided watch band 10 is short, the braided band 11 has a simple structure without any accessory, and has high integrity in appearance, which can satisfy a requirement of a user for quick mounting and removal.

It should be understood that both the first webbing layer C1 and the second webbing layer C2 shown in FIG. 9 are in a plain pattern. Specifically, each webbing layer of the first webbing layer C1 and the second webbing layer C2 is formed by braiding warp threads and weft threads. For example, numeral designations in FIG. 9 represents weft threads. Using the first webbing layer C1 as an example, the first webbing layer C1 include weft threads designated as 1, 5, 9, 13, 17, 21, 25, and 29. Solid lines around the foregoing weft threads with numeral designations are the warp threads. Certainly, the first webbing layer C1 and the second webbing layer C2 in an embodiment of this application may alternatively be configured to be in a twill pattern, a satin pattern, or another pattern. Details are not described herein again.

A weaving process is used in the braided band 11. A yarn main body uses nylon and spandex, and is appropriately supplemented with nylon or polyester hot fuse. After the braided band is formed, the hot fuse has a shape-preserving effect on the braided band 11. A width of the braided band 11 may be adjusted arbitrarily based on a need to adapt to the watch body 20. A length of the braided band 11 may be changed arbitrarily based on an actual need. In addition to being achieved by adjusting the quantity of the first webbing layer C1 or the second webbing layer C2, a thickness of the braided band 11 may further be achieved by replacing yarns of different thicknesses.

As for a size of the loop A in the braided band 11, lengths of the first braided band branch 11 and the second braided band branch 112 in the separate section S1 may be adjusted based on a size requirement. In addition, any details such as a position and a diameter of the loop A may be adjusted based on a requirement to satisfy different product requirements. Certainly, to ensure elasticity while facilitating a user to wear, ensuring hand feeling and surface appearance diversity, for example, high-elastic spandex covered yarn may be selected for warp yarns of the webbing layer close to the user in the braided band 11 between the two loops A shown in FIG. 8, and draw texturing yarn (draw texturing yarn, DTY) nylon may be selected for the webbing layer distant from the user. It should be understood that the foregoing structural configuration may alternatively be used in the entire braided band 11. Details are not described herein again.

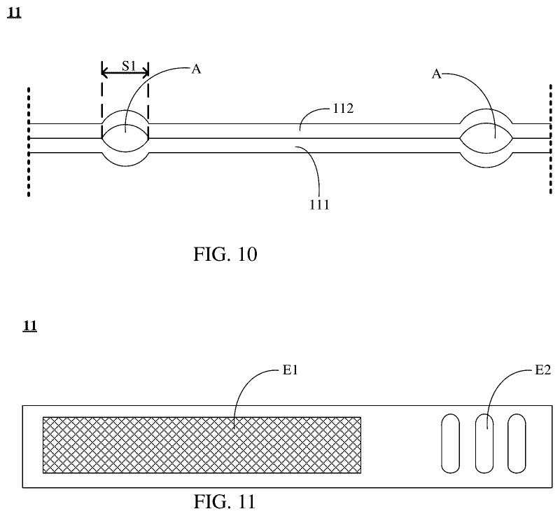

When the braided watch band 10 provided in an embodiment of this application is manufactured, refer to a structure shown in FIG. 10. The entire braided band is cut by using a laser or ultrasonic cutting process at dashed lines to form the braided band 11. For example, the braided band 11 shown in FIG. 10 has two loops A. It should be understood that because physical processes such as carbonizing and melting may exist when laser or ultrasonic cutting is used, a cutting mark may easily remain on a fabric surface. The mark may be mitigated by silkscreen printing, patching, and the like to satisfy an appearance requirement. It is worth noting that by adjusting the lengths of the first braided band branch 111 and the second braided band branch 112 in the separate section S1, a position of the cutting mark may be adjusted arbitrarily to satisfy the appearance requirement.

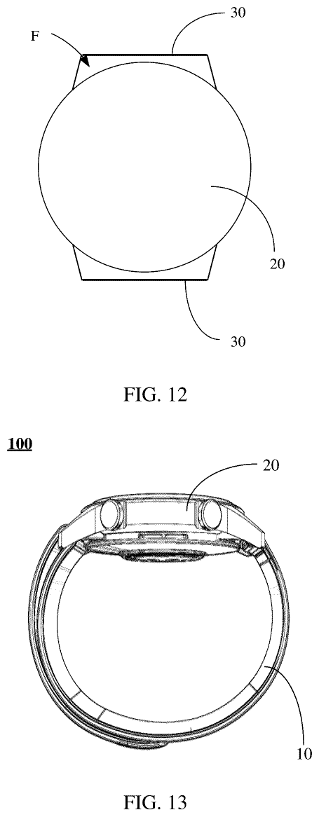

When the braided watch band 10 provided in this embodiment of this application shown in FIG. 10 is worn, the braided bands ii with different lengths need to be configured to fit a wrist circumference of a user. Certainly, to facilitate the user to flexibly adjust the length of the braided band 11, when the structure of the braided watch band 10 shown in FIG. 10 is specifically configured, only one loop A may be provided on the braided watch band 10. Specifically, one end of the braided band 11 is provided with the loop A. The braided band is connected to the watch body 20 through the loop A. As for a fixing manner of the other end of the braided band 11, a tail fixing structure may be provided on the braided band 11. The tail fixing structure may be configured to form an interlinked ring structure relative to the watch body 20. For example, according to a structure shown in FIG. 11, the tail fixing structure is a loop E1 and a hook E2 provided on an outer surface of the braided band 11. When the tail fixing structure is used, as shown in FIG. 12, a detachable mechanism is mounted on the watch body 20. For example, the detachable mechanism is provided as spring bars 30, and the spring bars 30 and lugs of the watch body 20 form a closed ring structure F. Certainly, another structural component may alternatively be selected as the detachable mechanism. Details are not described herein again.

Still refer to the structure of FIG. 12 with reference to FIG. 11. One end of the braided band 11 may be inserted into the closed ring structure F to form an interlinked ring structure. Specifically, after a tail of the braided band 11 passes through the closed ring structure F, the hook E2 is bonded to the loop E1 to form an interlinked ring structure, so that the braided watch band 10 can be fixed relative to the watch body 20, and a structure shown in FIG. 13 is formed as an example. It is worth noting that when the structure shown in FIG. 13 is used, a user can freely adjust a length of an actual use part of the braided band 11 based on a requirement to match the wrist, thereby achieving stepless adjustment.

Certainly, the tail fixing structure may alternatively be a snap (not shown) provided at the tail of the braided band 11. When the braided band 11 passes around the closed ring structure F of the watch body 20, the snap located at the tail of the braided band 11 is optionally inserted into the braided band to form the interlinked ring structure to fix the other end of the braided band relative to the watch body.

It should be understood that the tail fixing structure may alternatively be implemented by a plurality of other mechanisms. For example, the tail fixing structure may alternatively be a magnetic suction structure provided at the tail of the braided band 11. Details are not described herein again.

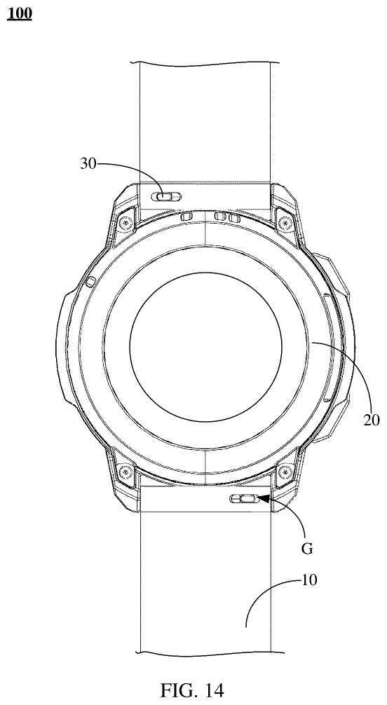

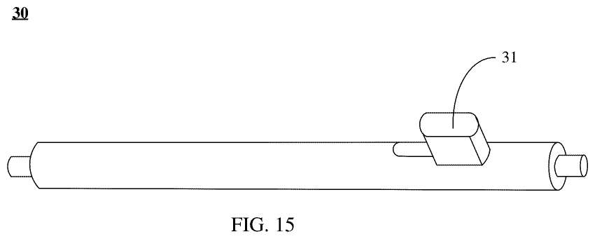

Refer to a structure shown in FIG. 14. When the braided watch band 10 is connected to the watch body 20 through the loop, the spring bars 30 shown in FIG. 14 may be used. Specifically, the spring bar 30 shown in FIG. 15 may insert into the loop A, and two ends of the spring bars 30 protruding out of the loop A may be connected to the watch body 20. When the spring bar 30 is specifically configured, a peripheral side of the spring bar 30 is provided with a release bar 31 according to a structure shown in FIG. 15. Refer to the structures shown in FIG. 14 with reference to FIG. 15. Avoiding holes G are provided on an inner surface of the loops A. The release bar 31 is embedded in the avoiding hole G, to facilitate a user to remove the spring bar 30 from the watch body 20, thereby achieving a purpose of quickly replacing the braided watch band 10.

Specifically, after a structure of the loop A is formed, laser cutting or a like process needs to be used to perform cutting at a head part to form the avoiding hole G, to enable insertion of the spring bar 30 with the release bar 31.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-10. (canceled)

11. A braided watch band, comprising:
a braided band comprising:
a first braided band branch and a second braided band branch arranged in a thickness direction, wherein the first braided band branch comprises at least one first webbing layer, wherein the at least one first webbing layer is arranged in a first band shape in a length direction, wherein the second braided band branch comprises at least one second webbing layer, and wherein the at least one second webbing layer is arranged in a second band shape in the length direction; and
a first binding yarn and a second binding yarn, wherein the first binding yarn in conjunction with the second binding yarn in the length direction braids the first braided band branch and the second braided band branch to form a separate section and one or more joint sections, wherein, in the one or more joint sections, the first binding yarn and the second binding yarn respectively pass through the first braided band branch and the second braided band branch to form an orthogonally locking structure;
wherein in the separate section, the first binding yarn passes through one of the first braided band branch or the second braided band branch, wherein the second binding yarn passes through the other of the first braided band branch or the second braided band branch; and
wherein one or more portions of the first braided band branch and the second braided band branch at the separate section form a loop.

12. The braided watch band according to claim 11, wherein each end of the braided band comprises the loop in the length direction.

13. The braided watch band according to claim 12, wherein an inner surface of the loop comprises an avoiding hole that avoids a release bar on a spring bar.

14. The braided watch band according to claim 11, wherein one end of the braided band comprises the loop, the braided band comprises a tail fixing structure, and wherein the tail fixing structure comprises an interlinked ring structure relative to a watch body to fix the other end of the braided band.

15. The braided watch band according to claim 14, wherein the tail fixing structure comprises a hook and loop connector on an outer surface of the braided band.

16. The braided watch band according to claim 11, wherein an inner surface of the loop comprises an avoiding hole that avoids a release bar on a spring bar.

17. The braided watch band according to claim 11, wherein the at least one first webbing layer and the at least one second webbing layer comprise one of a plain pattern, a twill pattern, or a satin pattern.

18. The braided watch band according to claim 11, wherein the braided band is integrally braided.

19. A watch, comprising:
a watch body;
a spring bar; and
a braided watch band, comprising a braided brand, comprising:
a first braided band branch and a second braided band branch arranged in a thickness direction, wherein the first braided band branch comprises at least one first webbing layer, wherein the at least one first webbing layer is arranged in a first band shape in a length direction, wherein the second braided band branch comprises at least one second webbing layer, and wherein the at least one second webbing layer is arranged in a second band shape in the length direction; and
a first binding yarn and a second binding yarn, wherein the first binding yarn works in conjunction with the second binding yarn in the length direction braids the first braided band branch and the second braided band branch to form a separate section and one or more joint sections, wherein, in the one or more joint sections, the first binding yarn and the second binding yarn respectively pass through the first braided band branch and the second braided band branch to form an orthogonally locking structure;
wherein in the separate section, the first binding yarn passes through one of the first braided band branch or the second braided band branch, wherein the second binding yarn passes through the other of the first braided band branch or the second braided band branch;
wherein one or more portions of the first braided band branch and the second braided band branch at the separate section form a loop; and
wherein at least one end of the braided watch band in the braided watch band comprises the loop, and the loop is connected to the watch body through the spring bar.

20. The watch according to claim 19, wherein each end of the braided band comprises the loop, wherein one spring bar is fitted in each loop, and wherein two ends of the spring bar protrude out of the loop to connect to the watch body.

21. The watch according to claim 20, wherein a peripheral side of the spring bar comprises a release bar that facilitates removal of the spring bar from the watch body.

22. The watch according to claim 19, wherein each end of the braided band comprises the loop in the length direction.

23. The watch according to claim 22, wherein an inner surface of the loop comprises an avoiding hole that avoids a release bar on the spring bar.

24. The watch according to claim 19, wherein one end of the braided band comprises the loop, wherein the braided band further comprises a tail fixing structure, and wherein the tail fixing structure comprises an interlinked ring structure relative to the watch body that fixes the other end of the braided band.

25. The watch according to claim 24, wherein the tail fixing structure comprises a hook and loop connector provided on an outer surface of the braided band.

26. The watch according to claim 19, wherein an inner surface of the loop comprises an avoiding hole that avoids a release bar on the spring bar.

27. The watch according to claim 24, wherein the spring bar is fitted in the loop, and two ends of the spring bar are pivotally connected to the watch body.

28. The watch according to claim 19, wherein the braided band is integrally braided.

29. The watch according to claim 19, wherein the at least one first webbing layer and the at least one second webbing layer comprise one of a plain pattern, a twill pattern, or a satin pattern.

30. The watch according to claim 19, wherein a peripheral side of the spring bar comprises a release bar that facilitates removal of the spring bar from the watch body.
